(19) United States
(12) Patent Application Publication
(10) Pub. No.: US 2004/0137383 A1
(43) Pub. Date: Jul. 15, 2004

(54) Photographic processing

(75) Inventor: John R. Fyson, Hackney (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/712,221

(22) Filed: Mar. 15, 2004

(30) Foreign Application Priority Data
Dec. 5, 2002 (GB) 0228355.4

(51) Int. Cl. G03C 7/42; G03D 5/04; G05B 15/00; G06F 17/00

(52) U.S. Cl. 430/430; 396/565; 396/604; 396/609; 396/627; 700/1; 707/1; 430/393; 430/943

(57) ABSTRACT

The invention provides a method of photographic processing, comprising the steps of applying a first component of a processing solution to the surface of a silver halide photographic material to be processed and applying a second component of the processing solution to the surface of photographic material to be processed. When the applied first and second components have mixed together, the processing solution is active to oxidise silver in the photographic material. The invention also provides a photographic processor suitable for carrying out the method.

### CROSS-REFERENCE TO RELATED APPLICATION

This is a U.S. Original Patent Application which claims priority on United Kingdom Patent Application No. 0228355.4 filed Dec. 5, 2002.

### FIELD OF THE INVENTION

The present invention relates to photographic processing and in particular to the processing of photographic materials including a silver oxidation step. The oxidation step might involve a bleaching step where silver in the photographic material is oxidised to a halide ready for subsequent removal in a fixing stage, or in low silver coating weight materials, stabilisation or just a washing step.

### BACKGROUND OF THE INVENTION

Conventionally, photographic processing involves a number of chemical processing steps carried out in sequence on exposed silver halide photographic material e.g. film. For example, in the processing of colour silver halide material, a first step is the developing using colour developer, which is followed by a bleaching or bleach-fixing step. The purpose of the bleaching or bleach-fixing step is to remove silver formed during dye formation in the developing using a colour developer. There may be some intervening steps such as a stop step. The bleaching or bleach-fixing is usually carried out in a tank.

Recently there have been moves to make processing machines smaller without tanks, the processing solutions being applied directly to the surface of the photographic material using an appropriate applicator or application method. Examples of suitable applicators include rollers or blades and examples of suitable application methods include spraying and inkjetting. Such applicators or application methods rely on the metered application of fresh processing materials (chemistry) so that each piece of material sees the same chemistry and is not subject to any previous processing history. This removes the need for constant process control, as there should be no change in processing solution constitution. This also removes the need for maintaining constant composition of tank chemistry by replenishment or other means.

Accordingly, replenishment pumps are no longer needed. Furthermore, since there are no processing tanks there is no recirculation required and so no need for any means of recirculation. This has the advantage that the number of pumps required is reduced, as these can be replaced with a metering pump to apply the solution in some manner to the surface of the photographic material. U.S. patent application Ser. No. 10/164,066 in the name of Evans et al discloses a method of photographic processing using image-wise surface application of processing solution.

U.S. Pat. Nos. 5,758,223 and 6,126,339 disclose examples of photographic processing methods involving methods of applying processing solutions.

In photographic processing, it is desirable to use chemicals which have as little effect on the environment as possible. Peroxide bleaches are examples of such a type of chemical. They can be used to remove efficiently and completely silver from an image using single-use chemistry with little environmental impact. Hydrogen peroxide is a powerful oxidant, but is a poor oxidant for silver. To use it, the pH and silver complexing power of the solution has to be carefully controlled. The least solution-sensitive peroxide bleaches operate at pH>8.0 in the presence of chloride ions, which are usually present in the system, carried in from previous developer and seasoned stop solutions. Unfortunately at higher pH, peroxide solutions are no longer stable. Although compounds can be added to improve the pH stability at high pH the solutions are only stable for a few days or weeks and would not allow for solution transportation or even storing in a conventional replenishment tank. Alternatively a catalyst can be added but this renders the solution unstable.

General properties of peroxide bleaches and the restrictions on their uses are described in “Electron Transfer in Chemistry” Vol. 5 ed. Balzani, V, p351 published Wiley-VCH. The use silver as a catalyst is described in A. Lumiere, L. Lumiere, L. Seyewetz, Bull. Soc. Fr. 1910, 1, 392.

### SUMMARY OF THE INVENTION

According to the present invention, there is provided a method of photographic processing, comprising the steps of:

applying a first component of a processing solution to the surface of a silver halide photographic material to be processed; and

applying a second component of the processing solution to the surface of photographic material to be processed, wherein the processing solution does not become active until the first and second components have mixed together, and wherein when the applied first and second components have mixed together, the processing solution is active to oxidise silver in the photographic material.

In one example, two components or stable parts of an oxidising processing solution such as a peroxide bleach are brought together either immediately before application to a photographic material. In an alternative example, two stable parts of the oxidising processing solution are brought together on application to the photographic material. Application may be by spraying, jetting or in any other suitable way.

As an extension, silver ions e.g. as a nitrate, are added to the processing solution in either one of the components. This accelerates the oxidising action of the processing solution.

### ADVANTAGEOUS EFFECT OF THE INVENTION

The invention provides a method of processing photographic material in which first and second active components of a processing solution are applied to photographic material to be processed.

This enables the use of unstable chemistry to carry out processing steps, as two or more stable component parts of an unstable processing solution can be brought together immediately before application, or even on the surface of the material being processed. The stable components can be stored for long periods of time enabling them to be transported or shipped. Furthermore, the invention enables contamination of the components of the processing solution to be avoided which is desirable since this can lead to further decomposition of the components and/or adverse sensitometric effects such as continued coupling in non-image areas of photographic material subsequently processed using solution formed from the contaminated components.

The invention also enables the use of a peroxide bleach, having little environmental impact, for efficiently and completely removing silver from an image using single-use chemistry. As explained above, peroxide bleaches only work in a confined range of pH and chloride concentration and are easily ‘upset’ by previous solutions. The stability of the processing solution is low, whereas the stability of the active components is high.

The application device may be configured such that it is not in contact with the photographic material being processed. This ensures that the first and second components are not mixed until immediately prior to or on their application to photographic material. In the case of a peroxide bleach, since the first and second components are not mixed until immediately prior to or on their application to photographic material contamination of the bulk of the components is avoided.

### BRIEF DESCRIPTION OF THE DRAWINGS

Examples of the present invention will now be described in detail with reference to the accompanying drawings, in which:

FIG. 1 shows a schematic representation of a side elevation of an apparatus according to the present invention;

FIG. 2 shows a schematic representation of a plan view of an apparatus according to the present invention;

FIGS. 3 and 4 show graphs of the variation of red density in the blue sensitive layer of an exposed photographic material, processed using the method of the present invention; and

FIGS. 5 to 7 show sensitometry relationships for photographic material processed according to the method of the present invention and processed using conventional processing methods.

### DETAILED DESCRIPTION OF THE INVENTION

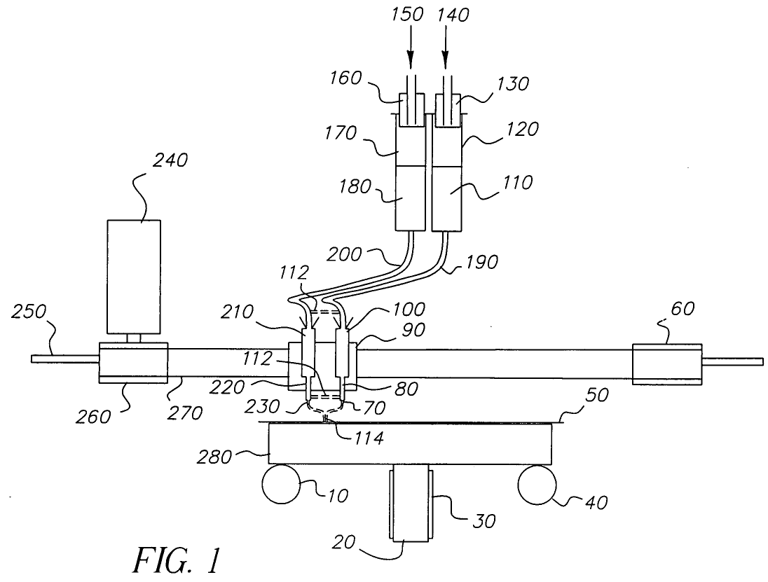

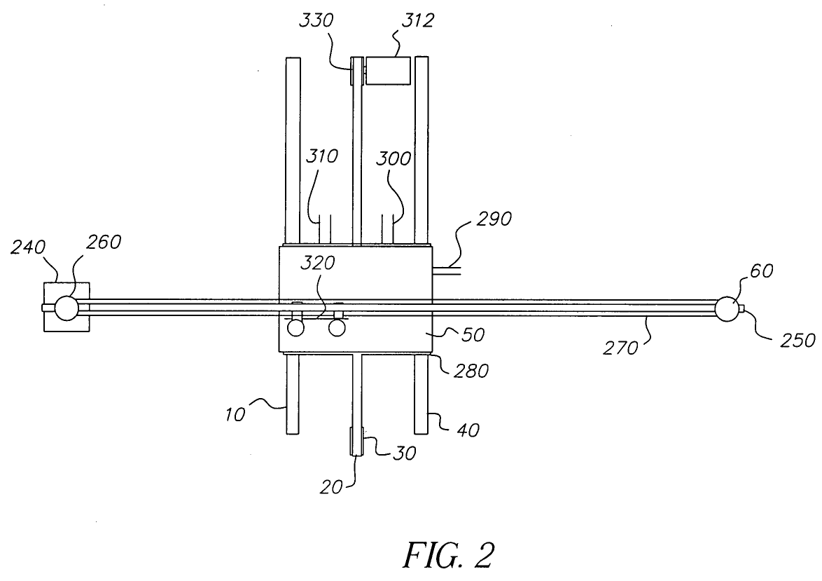

FIGS. 1 and 2 show respectively a schematic representation of a side elevation and a plan view of an apparatus according to the present invention for applying processing solution to the surface of photographic material. The apparatus is driven by an electrical power source coupled to electrical connections which are not shown.

The apparatus comprises a receiver e.g. a platen 280, driven relative to an assembly 320 of optionally moveable sources of two or more stable components of a processing solution. The platen 280 is adapted to receive a piece of photographic material to be processed by the processing solution. Each of the sources is arranged to provide a selected component of the processing solution so that mixing of the processing solution in this case occurs on the surface of the photographic material. Applying a coating of one component onto photographic material on which a coating of the other component has already been applied provides sufficient mixing of the components to ensure the processing solution is sufficiently reactive to function. In other words mixing can be said to have occurred when the two components react together to form a sufficiently reactive processing solution.

The platen 280 and moveable sources 320 of the components of processing solution are configured such that processing solution may be applied to any desired position on the platen 280. One way in which this may be achieved is by configuring the platen 280 and sources to move in mutually perpendicular directions in closely arranged parallel planes. As the assembly 320 and sources move relative to the platen the sources are controlled, either simultaneously or in sequence, to eject their respective components of processing solution onto the photographic material.

In the example shown the size of the platen 280 is 150×125 mm, and it is heated by tempered water passing through connections 300 and 310. The platen 280 is driven under the assembly 320 by a drive system in this case comprising a belt 20, pulleys 30 and 330 and a stepper motor 310. The stepper motor 310 is driven from a control box which is in turn controlled by a computer (not shown).

As explained above the jet assembly comprises two or more sources of components of processing solution. In this case the jet assembly 320 consists of two mounted sapphire orifices with holes 70 and 230 having a diameter of 75 microns. The holes 70 and 230 are connected to two fast acting solenoid valves 100 and 210 by silicone rubber tubes 80 and 220, respectively. Each of the solenoid valves includes an inlet 100 and 210, connected respectively to gas-powered syringes 120 and 170 again by means of flexible silicone rubber tubes 190 and 200.

In use, prior to operation of the apparatus, the syringes 120 and 170 are filled with components 110 and 180 respectively of processing solution. In accordance with image information or any other predetermined patter, the platen is moved relative to the assembly 320 whilst simultaneously components 110 and 180 of processing solutions are jetted as droplets from the syringes 120 and 170. As explained above, the assembly 320 is driven in a direction perpendicular and in a plane parallel to the platen movement. A drive system comprising a stepper motor 240 coupled to a belt 270 around pulleys 60 and 260 may be used. In the example shown, the jetting is stimulated by application of a suitable electrical pulse to the solenoid valves 100 and 210. This pulse is generated by means of a pulse shaper (not shown). The pulse length and timing may be controlled by means of the same computer controlling the movement of the platen and the jet assembly 320.

Optionally, a single nozzle opening 114 may be used to output a mixture of the components 110 and 180 of processing solution. In this case, a connection 112 may be provided between the holes 70 and 230 to ensure that mixing of the components to form the processing solution occurs immediately prior to application of the solution to the photographic material.

A computer program run on a computer controls the process of application of processing solutions. The position and movement of the platen 280 relative to the jet assembly 320 is controlled by arranging the apparatus in a predefined position determined by detection using microswitches, not shown in the diagrams. Typically, the microswitches are arranged such that when the platen has moved to a predetermined position the switches are caused to engage. This defines a position with reference to which subsequent movement of the platen 280 can be controlled. The microswitches provide a means of defining a reference position against which subsequent movement of the platen 280 can be controlled. Other suitable means for defining such a position may also be used e.g. an optical position sensor or a mechanical stop.

The jet assembly 320 and platen 280 is then moved so that one corner of a piece of paper, held on the heated platen 280 by means of vacuum supplied via inlet 290 is under orifice 230. The jet assembly 320 is moved about 1 mm by pulses sent to the stepper motor 240 and a pulse is sent to the solenoid valve 210 so that a drop of one of the components of the processing solution is fired on to the paper. The jet assembly 320 is then advanced until a line of drops has been fired at the paper.

The size of the fired drops and the physical properties, such as surface tension, of the components of the solution fired are controlled so that the drops just overlap and the liquids run together. At the end of the paper the platen is advanced about 1 mm and a line of drops is written to the paper in the opposite direction to the first line. This process is completed when the platen has travelled far enough to ensure that the entire surface of the paper has been coated with the processing solution. The process is then repeated after a timed delay by firing the other solution 110 from orifice 70. In this way two components of the processing solution are laid down.

The solution may be applied in a uniform coating to the material being processed. Alternatively it may be applied image-wise e.g. in dependence on image density.

### EXAMPLES

The method of the present invention was used with the following processing solutions:

### Example 1

The following solutions were prepared:

| Developer 1 | | |
|---|---|---|
| water | 800 | ml |
| N,N′ diethyl hydroxylamine | 4 | g |
| potassium carbonate | 25 | g |
| CD3 | 5 | g |
| sodium chloride | 1 | g |
| water to | 1 | litre |
| pH adjusted to 10.1 | | |
| Stop Fix | | |
| water | 800 | ml |
| sodium metabisulphate | 100 | g |
| water to | 1 | litre |
| no pH adjustment | | |
| Control Bleach-Fix | | |
| water | 700 | ml |
| 1.56molar ammonium iron (III) EDTA solution | 100 | ml |
| ammonium thiosulphate | 100 | g |
| acetic acid | 10 | ml |
| water to | 1 | litre |
| pH adjusted to 6.0 with sulphuric acid or sodium hydroxide | | |
| Peroxide Bleach | | |
| water | 800 | ml |
| sodium bicarbonate | 5 | g |
| 30% Hydrogen Peroxide | 100 | ml |
| sodium chloride | 5 | g |
| water to | 1 | litre |
| pH adjusted to 10.0 with sulphuric acid or sodium | | |
| hydroxide | | |
| Fixer | | |
| Kodak 3000 fixer | 100 | ml |
| Water to | 1 | litre |

300×25 mm strips of Kodak Ektacolor Edge 8 colour paper were exposed on a sensitometer to a 0.15 step 3 colour+neutral wedge for 1/10s with correction filters added to an approximate black and white image for a neutral exposure. The strips were processed in upright processing tanks agitated with nitrogen bursts. The process was as follows using 3 different bleaches as indicated.

Process (all steps at 35 C)

| | |
|---|---|
| developer 1 | 45 s |
| stop-fix | 45 s |
| bleach(control bleach-fix or peroxide or missed out) | 60 s |
| fixer | 45 s |
| wash (flowing water) | 60 s |
| dry at room temperature | |

After processing, the densities of the strips were measured on an automatic densitometer and the results compared to those of a strip processed in a standard process using Ektacolor Prime bleach-fix to remove the silver. As a measure of the retained silver, the red density in the blue exposed image was used. The peroxide bleach was kept overnight and the experiment repeated.

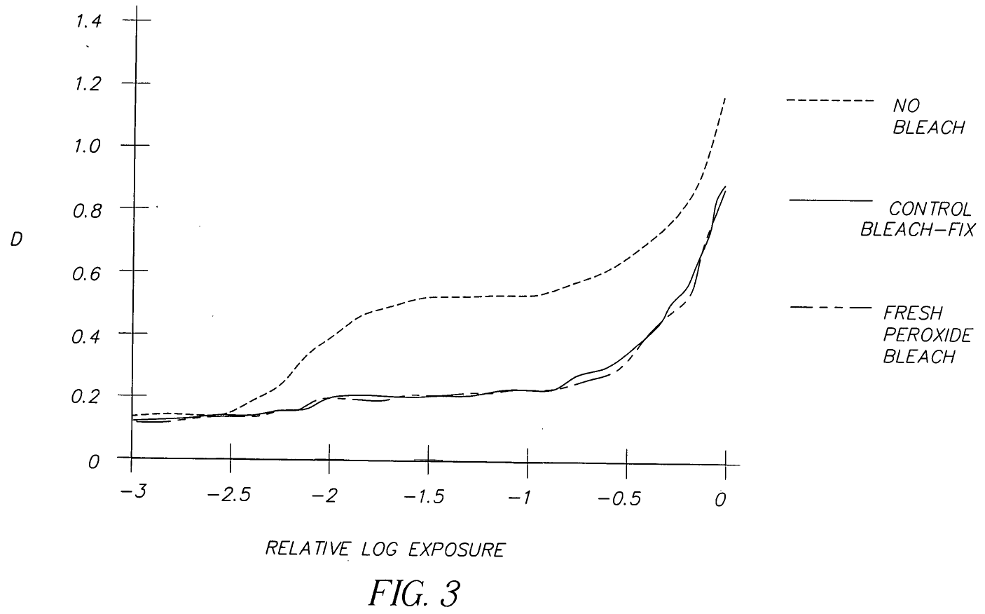

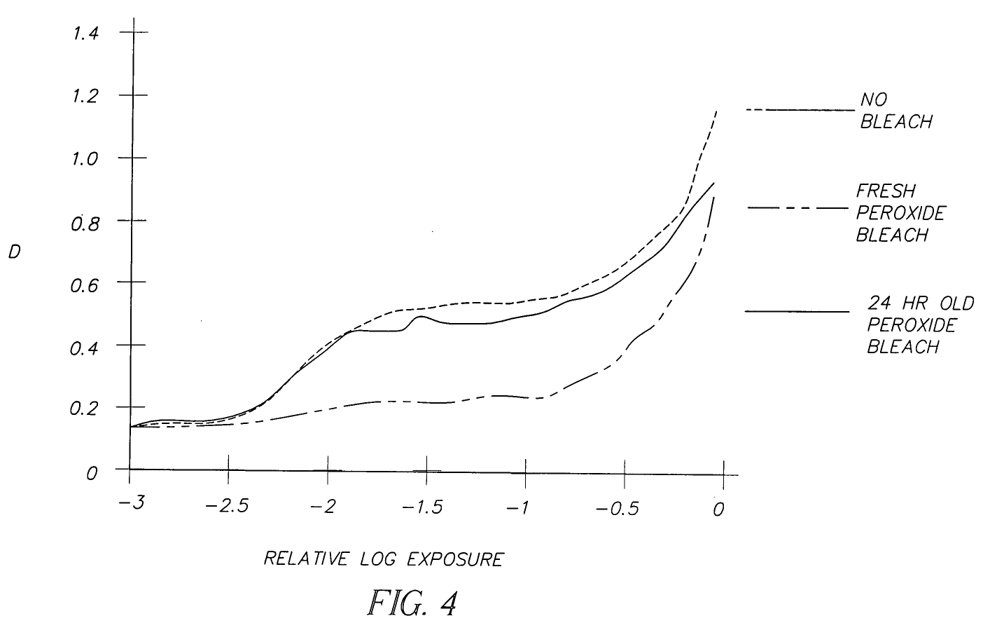

The results are shown in the FIGS. 3 and 4. The peroxide bleach when used fresh more-or-less matches the control carried out with a conventional iron (III) bleach-fix. However, after standing overnight the peroxide bleach has lost its activity. This shows the instability of a peroxide bleach.

### Example 2

Peroxide Bleach 2 Component A

| | | |
|---|---|---|
| water | 700 | ml |
| 30% hydrogen peroxide | 200 | ml |
| sodium chloride | 5 | g |
| water to | 1 | litre |

pH adjusted to 10.0 with sulphuric acid or sodium hydroxide

Peroxide Bleach 2 Component B

| | | |
|---|---|---|
| water | 800 | ml |
| sodium carbonate | 20 | g |

pH adjusted to 10.0 with sulphuric acid or sodium hydroxide Components A and B of Peroxide Bleach 2 were put in two separate sections of a previously emptied and washed out “Hewlett-Packard” colour ink-jet cartridge designed for use with a “DeskJet 420” printer. This was facilitated by prising the top off the cartridge. The top was taped back after refilling. The remaining section of the colour cartridge was left empty.

A “Hewlett-Packard” “DeskJet 420” printer was connected to a suitable PC, loaded with the appropriate drivers. Parts of this printer was removed to allow pieces of 150 mm wide photographic paper to be transported under the ink-jet cartridge without the surface being touched by either the cartridge or a roller. The refilled ink-jet cartridges were then loaded according to the maker's instructions, into these printers. Suitable files written in “Adobe PhotoShop” that could be sent to each of the printer to cause them to “print” solution at a rate of 20 ml/m² from each filled section of the cartridge, over an exposed area on the photographic paper.

150×25 mm strips of Kodak Ektacolor Edge 8 were exposed to a ˜0.3 log exposure web for 1/10s. These exposed strips were processed in Developer 1 and Stop Fix in upright processing tanks for 45s in each bath at 35° C. These strips were then blotted dry with absorbent towelling. The strips were then put into the modified ink-jet printers and the two parts of the bleach applied. After bleach application the strips were left for one minute before being treated with Fixer for 45s and washed for 1 minute before drying at room temperature. The densities of the strips were measure and compared to similar strips processed at 35° C. in the following ‘control’ process in upright processing tanks.

| | |
|---|---|
| Developer 1 | 45 s |
| Stop-Fix | 45 s |
| Bleach Fix | 45 s |
| Wash | 60 s |

Dry at room temperature

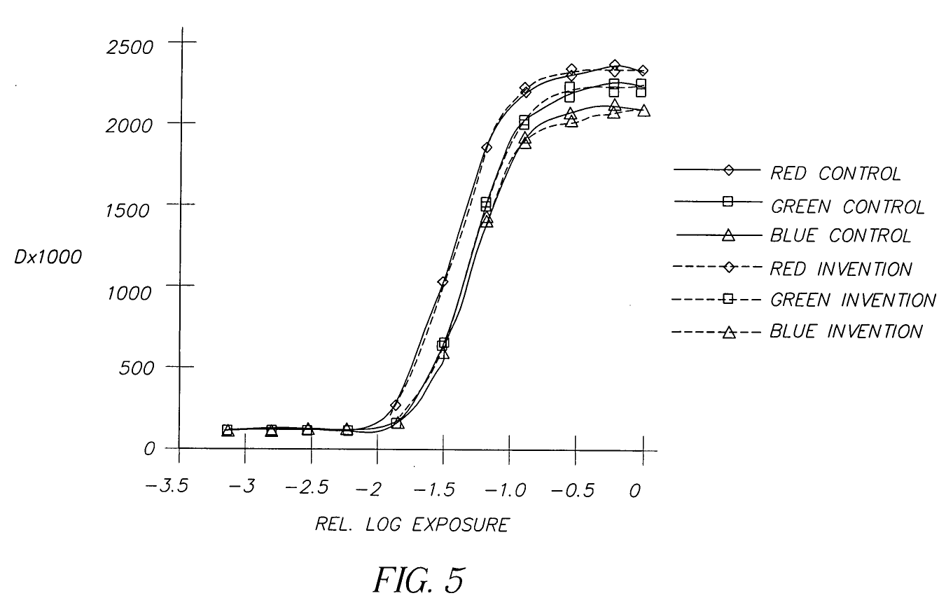

The results are compared in FIG. 5.

Paper processed using the peroxide bleach of the invention, then a fix combination had very similar sensitometry as the bleach-fix process of the control.

### Example 3

In this example, with the exception of the final washing stage, the entire process was carried out using an ink-jet applicator as described with reference to FIGS. 1 and 2.

Developer 2

| | | |
|---|---|---|
| water | 800 | ml |
| 2-pyrolidinone | 200 | g |
| N,N′ diethyl hydroxylamine | 10 | g |
| NaOH | 10 | g |
| CD3 free base* | 30 | g |
| Silwet L-7607 (TM Witco Chemical Co.) | 5 | g |
| water to | 1 | litre |
| pH adjusted to 13.2 | | |

*CD free base preparation

0.5 g hydroxylamine sulphate and 0.5 g sodium sulphite (these were present as anti oxidants) were dissolved in 50 mls of water. Into this was dissolved 10 g CD3. To this mixture was added potassium hydrogen carbonate very slowly until the pH rose to about 8 (using papers to test). The CD3 free base had mostly precipitated. This mixture was then shaken in a separating funnel with 200 mls ethyl acetate to extract the free base. The solid was extracted into the ethyl acetate. The mixture was separated and the ethyl acetate phase allowed to evaporate in an evaporating dish in the fume cupboard overnight at room temperature. No further purification was attempted as it was thought this might encourage oxidation. The free base was obtained as small very pale brown-grey crystals.

The developer and stop-fix (see example 1) were put in previously emptied “Hewlett Packard” black ink-jet cartridges designed for use with a “DeskJet 420” printer. This was facilitated by the drilling of a small hole in the top of the cartridges.

Four “Hewlett Packard” “DeskJet 420” printers were connected to a suitable PC, loaded with the appropriate drivers, through a switch to enable them to be controlled independently. Parts of these printers were removed to allow pieces of 150 mm wide photographic paper to be transported under the ink-jet cartridge without the surface being touched by either the cartridge or a roller. The refilled ink-jet cartridges were then loaded according to the maker's instructions, into these printers. Suitable files written in “Adobe PhotoShop” that could be sent to each of the printers to cause them to “print” solution at a rate of 20 ml/m² over an exposed area on the photographic paper.

One printer was loaded with a cartridge containing Developer 2, another with Stop Fix, one with Peroxide Bleach 2 component A and the last with Peroxide Bleach 2 component B. c150×125 mm strips of Kodak Ektacolor Edge 8 were exposed to a ˜0.3 log exposure web for 1/10s.

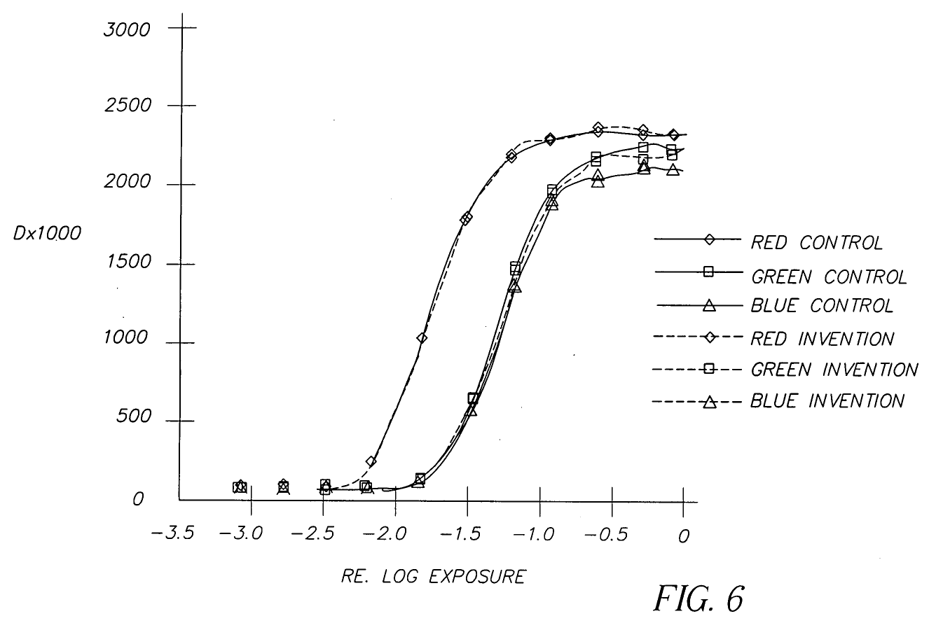

The strips were processed in the dark at room temperature (23° C.) as follows: the print file was downloaded to all four printers. No printing took place until paper was sensed by them. The exposed paper was put in the printer containing developer1, whereupon ‘printing’ started and developer was laid down at 20 mls/m². When the “printing” of the print had finished the paper was held in the hand until 1 minute had elapsed since the start of the developer application. The print was put in the printer containing the Stop Fix. After application of the Stop Fix the paper was fed into the printer containing Peroxide Bleach 2 component A. Immediately after this liquid had been applied, the paper was fed into the fourth printer containing Peroxide Bleach 2 component B. The strip was left for 1 minute before being treated with Fixer in a tray and then washed in running water for 1 minute and then dried. The sensitometry of this strip was compared to one which had been processed identically except that the third and fourth ink jet printer cartridges had been filled with bleach-fix. The results are shown in FIG. 6.

### Example 4

| Developer 3 | | |
|---|---|---|
| water | 800 | ml |
| N,N′ diethyl hydroxylamine | 10 | g |
| NaOH | 8 | g |
| CD3 salt | 10 | g |
| Silwet L-7607 (TM Witco Chemical Co.) | 4 | g |
| water to | 1 | litre |
| pH adjusted to 12.3 | | |
| Stop | | |
| acetic acid glacial | 100 | ml |
| Silwet L-7607 (TM Witco Chemical Co.) | 4 | g |
| water to | 1 | litre |

Mixed Peroxide Bleach

The mixed peroxide bleach was made by mixing components A and B of Peroxide Bleach described in example 2 immediately before use.

Control Bleach-Fix

See Example 1.

Fixer

As Example 2.

With reference to the apparatus shown in FIGS. 1 and 2, syringes 170 and 120 were charged with Developer 3 and Stop respectively. Exposed strips of paper similar to those used for Examples 2 and 3 were used for the experiment. In the dark, a strip was placed on the platen and a vacuum applied to hold it in position.

The pressure in the syringes was set at 0.65 bar and a pulse length to open the valves was set at 0.5 ms. With this set up and with the processing solution used, a laydown of approximately 65 ml/m² for each solution was achieved. The platen was heated to 40° C. with circulating water.

The apparatus was started and Developer 3 laid down on the surface, taking 27s. After 3 further seconds the Stop was laid down in the same pattern such that all the coated paper surface received a development time of 30s (27+3). After a further 30s the surface was squeegeed with a rubber blade and the light in the room turned on to facilitate the remainder of the process. Syringe 170 was quickly washed out and the liquid was replaced with Mixed Peroxide Bleach. This was then laid down in the same manner as the developer. After completion of the bleach application, the strip was left for a further 30s to allowing bleaching to complete. The strip was then taken off the platen fixed in the Fixer for 30s and washed for 60s before being hung up to dry. The experiment was repeated, substituting the Control Bleach-Fix for the Mixed Peroxide Bleach.

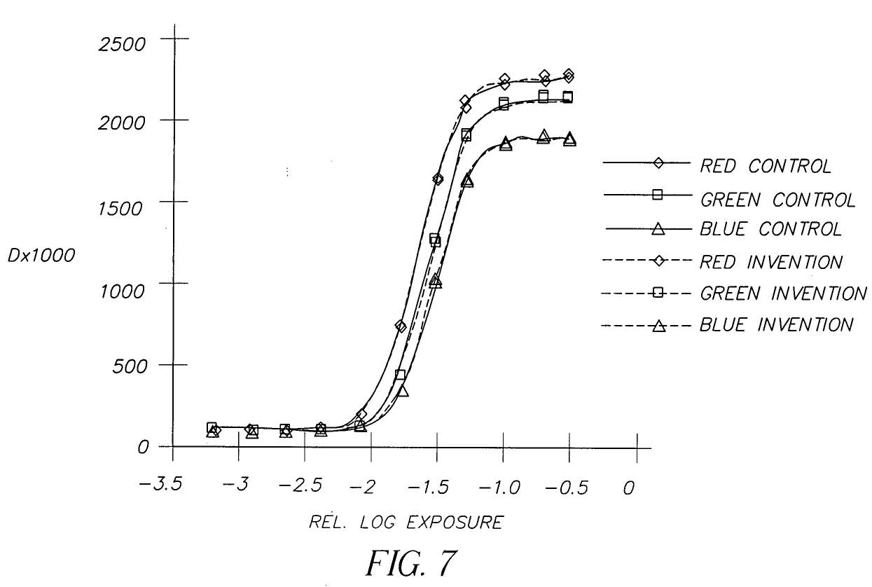

The sensitometry of the wedges were read and compared. The results are shown in FIG. 7. Again, comparable results are obtained with a peroxide bleach and fix, compared to a bleach-fix.

What is claimed is:

1. A method of photographic processing, comprising the steps of:
applying a first component of a processing solution to the surface of a silver halide photographic material to be processed; and
applying a second component of the processing solution to the surface of photographic material to be processed, wherein when the applied first and second components have mixed together, the processing solution is active to oxidise silver in the photographic material.

2. A method according to claim 1, in which the first and second components of the processing solution are mixed together immediately prior to application to the surface of the photographic material.

3. A method according to claim 1, in which the first and second components of the processing solution are applied separately and in which they mix together on the surface of the photographic material.

4. A method according to claim 1, in which the first and second components of the processing solution are components of a peroxide bleach.

5. A method according to claim 1, in which one of the components of the processing solution includes silver ions to accelerate the oxidising action of the processing solution.

6. A photographic processor, comprising:
a receiver for receiving photographic material to be processed; and
a processing solution applicator for applying a processing solution to a surface of the photographic material, wherein the processing solution applicator comprises a source of a first component of a processing solution and a source of a second component of the processing solution, the applicator being adapted to mix said first and second components of the processing solution either on or immediately prior to application of the processing solution to a surface of the photographic material.

7. A photographic processor according to claim 6, in which the processing solution applicator comprises a nozzle assembly for jetting the components of the processing solution onto the photographic material.

8. A photographic processor according to claim 7, in which the nozzle assembly comprises a respective nozzle for applying each component of the processing solution separately.

9. A photographic processor according to claim 8, in which the nozzle assembly comprises a unitary nozzle for applying the mixed components of the processing solution together.

10. A photographic processor according to claim 6, in which the receiver is arranged at a separation relative to the processing solution applicator such that when photographic material is arranged in the receiver a spacing is maintained between the photographic material and the processing solution applicator.

11. A photographic processor according to claim 6, further comprising a drive mechanism to drive the receiver and processing solution applicator relative to each other.

12. A photographic processor according to claim 6, further comprising a control unit to control movement of the receiver and processing solution applicator relative to each other and application of the processing solution.

13. A photographic processor according to claim 12, in which the control unit comprises a microprocessor.

14. A computer program which when run on a computer causes said computer to function as the control unit in claim 12.
